(19) United States
(12) Patent Application Publication
(10) Pub. No.: US 2007/0184248 A1
(43) Pub. Date: Aug. 9, 2007

(54) Structure of cushion pad

(76) Inventor: Po-Jen Pai, Taipei City (TW)

Correspondence Address: BACON & THOMAS, PLLC, 625 SLATERS LANE, FOURTH FLOOR, ALEXANDRIA, VA, 22314, US

(21) Appl. No.: 11/348,415

(22) Filed: Feb. 7, 2006

(51) Int. Cl. B32B 3/00

(52) U.S. Cl. 428/156; 428/178

(57) ABSTRACT

A structure of cushion pad, it can have corresponding buffering effects against various states of force suffered, and at least has a main body formed of elastomer; the main body has a first buffering surface provided perpendicular to a force acting direction, and has a second buffering surface provided on the back side opposite to the first buffering surface. The first buffering surface is provided with a plurality of recesses arranged to be spaced from one another, the spaces in the recesses form air columns, in order that when the main body is compressed under a vertical pressure, the air columns can provide functions of supporting and buffering; the second buffering surface is provided with a plurality of protruding stubs arranged to be spaced from one another, in order to uniformly scatter and buffer the action force generated by the air columns on the main body.

### BACKGROUND OF THE INVENTION

1. Field of the Invention

The present invention is related to a structure of cushion pad, and especially to a structure of cushion pad used for an article to be rammed on by a ramming article, the structure can buffer and uniformly scatter the ramming force.

2. Description of the Prior Art

A cushion pad is an article used between an article to be rammed and a ramming article to scatter the ramming force; in our daily lives, cushion pads are widely used as shoe pads or used for other areas often have the phenomenon of ramming.

To get an effect of buffering, mostly the effects of buffering of conventional structures of cushion pad depend on the thicknesses used for soft materials for the structures; the larger the thickness of a cushion pad is, the longer the stroke of buffering it will present, and naturally its effect of buffering is better.

When an area having the phenomenon of ramming is under a condition that ramming forces often change or the area is subjected to suffering larger ramming forces, the conventional structures of cushion pad always are unable to resist larger ramming forces. For a cushion pad used on a shoe for instance, when in normal walking of a user, the cushion pad must have a certain degree of supporting function to surely transmit the treading force of the user to the ground, to thereby avoid creating undue buffering action that renders walking of the user harder; the function of the cushion pad is to uniformly scatter the pressure force between a foot of the user and the ground, and to provided a small buffering function to increase comfort of the user. When a larger ramming force is created between the foot of the user and the ground, the cushion pad shall be able to scatter the larger ramming force to thereby prevent the larger ramming force from hurting the foot; an often seen conventional structure of cushion pad is unable to have such an effect of having both the functions of supporting and buffering.

### SUMMARY OF THE INVENTION

The present invention provides the following technical measures to render a cushion pad to have both the functions of supporting and buffering and to render the function of buffering more elevated.

The structure of cushion pad of the present invention at least has a main body formed of elastomer; the main body has a first buffering surface provided perpendicular to the force acting direction, and has a second buffering surface provided on the back side opposite to the first buffering surface. The first buffering surface is provided with a plurality of recesses arranged to be spaced from one another, the spaces in the recesses form air columns, in order that when the main body is compressed under a vertical pressure, the air columns can provide functions of supporting and buffering; the second buffering surface is provided with a plurality of protruding stubs arranged to be spaced from one another, in order to uniformly scatter and buffer the action force generated by the air columns on the main body.

Secondly, the structure of cushion pad further includes a first clamping layer combined with the first buffering surface to always seal the air columns; and the structure of cushion pad further includes a second clamping layer combined with the second buffering surface to cover an air net formed among the protruding stubs, thereby air can flow all around in the air net when the second buffering surface is pressed. When the above stated elastomer is molded crystal gel, the best effect of buffering can be obtained.

The abovementioned main body can provide a supporting force against normal pressing on the cushion pad, and can generate suitable slight buffering action by slight deformation of the air columns and the protruding stubs; when the main body is suffered from a larger impact force, the air columns provided in the first buffering surface can bear and buffer the larger impact force. By virtue that the air columns may generate corresponding action force on the main body when the air columns are strongly pressed, and by providing the protruding stubs on the second buffering surface, the action force that the air columns exerts on the main body can be further uniformly scattered and buffered.

The first buffering surface can be used to always seal the air columns and to increase the effects of supporting and buffering, after combining of the second clamping layer with the second buffering surface, the air net formed among the protruding stubs can be covered, thereby air can flow all around in the air net when the second buffering surface is pressed.

Therefore, the structure of cushion pad of the present invention can present corresponding buffering effects in pursuance of different state of force exerted; such a cushion pad presenting corresponding buffering effects in pursuance of different state of force exerted particularly is suitable to be provided in a shoe, in order that a user can get different buffering effects during walking and jumping.

The present invention will be apparent after reading the detailed description of the technical measurements and the preferred embodiments thereof in reference to the accompanying drawings.

### BRIEF DESCRIPTION OF THE DRAWINGS

FIG. 1 is a perspective schematic view showing a first embodiment of the present invention;

FIG. 2 is a sectional view of the first embodiment of the present invention;

FIG. 3 is a sectional schematic view showing the first embodiment of the present invention is suffered from a pressing force;

FIG. 4 is a sectional schematic view showing the first embodiment of the present invention is suffered from a pressing force with a larger impact;

FIG. 5 is a sectional schematic view showing a second embodiment of the present invention.

### DETAILED DESCRIPTION OF THE PREFERRED EMBODIMENT

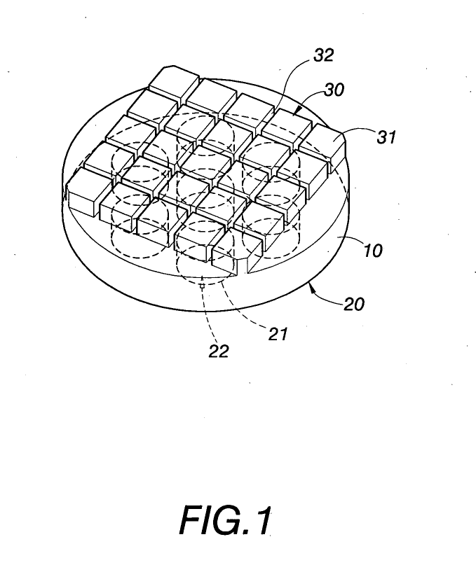

Referring firstly to FIG. 1 which is a perspective schematic view showing a first embodiment of the present invention, the drawing depicts that the main structure of the cushion pad is a main body 10, the main body 10 is made of elastomer which can be molded crystal gel, thereby the main body 10 can thus get an appropriate supporting function.

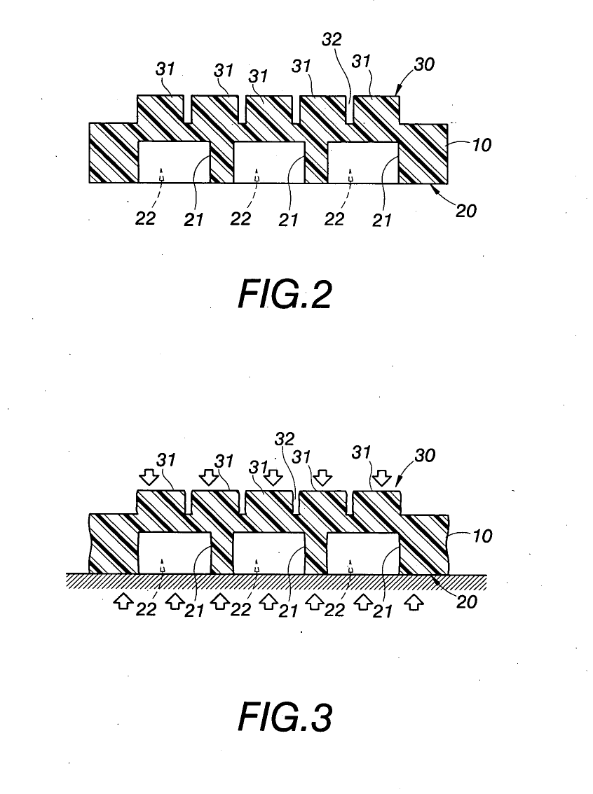

Please refer simultaneously to FIGS. 1 and 2, the latter is a sectional view of the first embodiment of the present invention, the main body 10 has a first buffering surface 20 (the bottom surface shown in the drawing) provided perpendicular to the force acting direction, and has a second buffering surface 30 provided on the back side opposite to the first buffering surface 20.

The first buffering surface 20 is provided thereon with a plurality of recesses 21 arranged to be spaced from one another, the spaces in the recesses 21 form air columns 22 on the main body 10; and the second buffering surface 30 is provided with a plurality of protruding stubs 31 arranged to be spaced from one another, an air net 32 having recessed areas is formed among the protruding stubs 31. In this embodiment, the recesses 21 are round grooves, the protruding stubs 31 are rectangular stubs; the sectional area of each the protruding stubs 31 is smaller than that of any of the recesses 21.

As shown in FIG. 3 which is a sectional schematic view showing the first embodiment of the present invention is suffered from a pressing force; when the cushion pad is suffered from a pressing force, the main body 10 provides an appropriate supporting force, and can generate suitable slight buffering action by slight deformation of the air columns 22 and the protruding stubs 31.

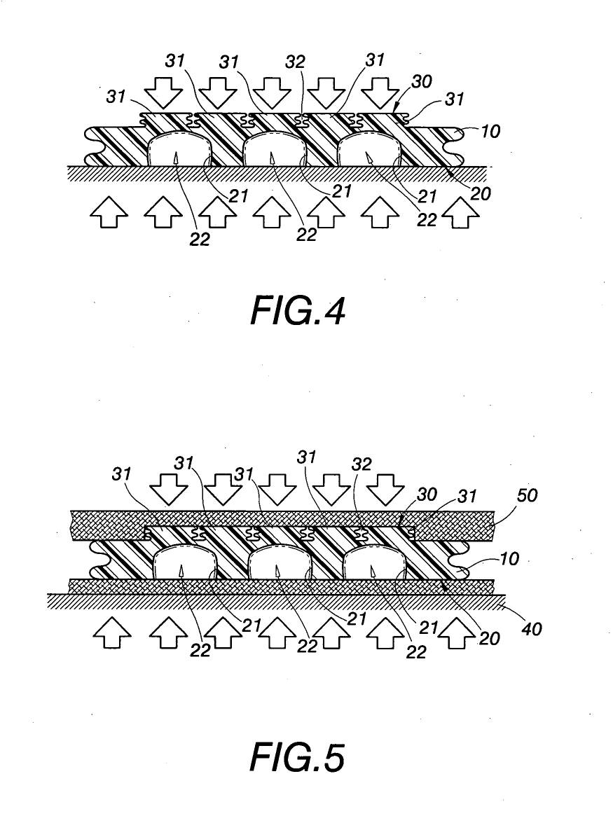

FIG. 4 is a sectional schematic view showing the first embodiment of the present invention is suffered from a pressing force with a larger impact; when the structure of cushion pad is suffered from a larger impact force, the air columns 22 provided in the first buffering surface 20 can bear and buffer the larger impact force. By virtue that the air columns 22 may generate corresponding action force on the main body 10 when the air columns 22 is strongly pressed, and by providing the protruding stubs 31 on the second buffering surface 30, the action force that the air columns 22 exerts on the main body 10 can be further uniformly scattered and buffered.

FIG. 5 is a sectional schematic view showing a second embodiment of the present invention, the structure of cushion pad further includes a first clamping layer 40 combined with the first buffering surface 20 to always seal the air columns 22 to increase the effects of supporting and buffering of the air columns 22. The structure of cushion pad further includes a second clamping layer 50 combined with the second buffering surface 30 to cover the air net 32, thereby air can flow all around in the air net 32 when the second buffering surface 30 is pressed. By the ability of flowing all around in the air net 32 of air and the function of the protruding stubs 31, the second buffering surface 30 can have better effects of pressure buffering and scattering.

With the above stated embodiments, the structure of cushion pad of the present invention can have corresponding buffering effects against various states of force suffered; the structure particularly is suitable for a shoe, so that when such a structure is provided in a shoe, a user can get different buffering effects during walking and jumping.

The embodiment stated above is only for illustrating the present invention, it will be apparent to those skilled in this art that various equivalent modifications or changes according to the idea of and without departing from the spirit of this invention shall also fall within the scope of the appended claims.

1. A structure of cushion pad, said structure at least has a main body formed of elastomer; said main body has a first buffering surface provided perpendicular to the direction of an acting force, and has a second buffering surface provided on the back side opposite to said first buffering surface; said first buffering surface is provided with a plurality of recesses arranged to be spaced from one another, spaces in said recesses form air columns, in order that when said main body is compressed under a vertical pressure, said air columns provide functions of supporting and buffering; said second buffering surface is provided with a plurality of protruding stubs arranged to be spaced from one another, in order to uniformly scatter and buffer said acting force generated by said air columns on said main body.

2. The structure of cushion pad as in claim 1, wherein: said structure of cushion pad further includes a first clamping layer combined with said first buffering surface to always seal said air columns.

3. The structure of cushion pad as in claim 1, wherein: said structure of cushion pad further includes a second clamping layer combined with said second buffering surface to cover an air net formed among said protruding stubs, thereby air flows all around in said air net when said second buffering surface is pressed.

4. The structure of cushion pad as in claim 1, wherein: said elastomer is molded crystal gel.

5. The structure of cushion pad as in claim 1, wherein: the sectional area of each of said protruding stubs is smaller than that of any of said recesses.
